(19) United States
(12) Patent Application Publication
(10) Pub. No.: US 2007/0050453 A1
(43) Pub. Date: Mar. 1, 2007

(54) Taylor made email

(76) Inventor: Taylor Christopher Carthern, Atlanta, GA (US)

Correspondence Address: Taylor Carthern, 110 Old Fairburn Close, Atlanta, GA, 30331, US

(21) Appl. No.: 11/210,216

(22) Filed: Aug. 23, 2005

(51) Int. Cl. G06F 15/16; G06Q 30/00

(52) U.S. Cl. 709/206; 705/14

(57) ABSTRACT

Our invention will be used for cell phones, PDA'S, and computers. We will have different celebrities, entertainers, athletes, politicians, artists, and etc. saying their own personalized message when you log into your email, or when you are connected and you receive a new message. The person that you have on your email may have either their picture, or video of them saying the message or they will have no picture. A person will be able to have many different messages at one time, and they will be able to have like caller groups, where they can associate different addresses or commonly used addresses with different celebrities. Ex., it is like when you choose different ring tones for different friends and family. You will be able to have different email messages for different friend's email addresses. For example you may have your friends email be associated with your favorite athlete and your parents email be associated with a minister like T. D. Jakes. People will be able to create their own message, with or without, picture or video. You can say whatever you want, ex, Yo, You got a package. All messages will be personalized to the celebrities or individual's preference. Messages will come as a pop up when you receive messages. On personalized messages you will be able to use your voice for messages, but use pictures of anything to pop up. For example you may want to use a picture of your mother to be associated with her emailing you, or even your dog, or your favorite shoe. You do not have to use a picture or video of yourself You can have video of your friend when he has emailed you to pop up. A message will pop up when you receive an instant message from anyone, you can also set a person's address to be associated with a particular message. When you receive an instant message, a message from a celebrity or even yourself or your friend can pop up with or without picture or video.

### BACKGROUND-FIELD OF INVENTION

This present invention relates to having a when you sign in your email account and you hear the phrase you got mail. It is an automated message and the idea that we will enhance to make it even popular.

### OBJECTS AND ADVANTAGES

Several of the advantages of my invention include:
1. Our design will enhance the use of email for telephones.
2. Fans will be able to have their favorite celebrity's message on their email.
3. You will be able to customize your own message with video and/or picture.

### SUMMARY OF INVENTION

Our invention will be used for cell phones, PDA'S, and computers. We will have different celebrities, entertainers, athletes, politicians, artists, and etc. saying their own personalized message when you log into your email, or when you are connected and you receive a new message. The person that you have on your email may have either their picture, or video of them saying the message or they will have no picture. A person will be able to have many different messages at one time, and they will be able to have like caller groups, where they can associate different addresses or commonly used addresses with different celebrities. For example you may have your friends email be associated with your favorite athlete and your parents email be associated with a minister like T. D. Jakes. People will be able to create their own message, with or without, picture or video. You can say whatever you want, ex, Yo, You got a package. All messages will be personalized to the celebrities or individual's preference. Messages will come as a pop up when you receive messages. We will also have messages from people pop up when you receive an instant message when using your phone, PDA, or even a computer.

### BRIEF DESCRIPTION OF DRAWINGS

N/A

### DETAILED DESCRIPTIONS OF DRAWINGS

Our invention will be used for cell phones, PDA'S, and computers. We will have different celebrities, entertainers, athletes, politicians, artists, and etc. saying their own personalized message when you log into your email, or when you are connected and you receive a new message. The person that you have on your email may have either their picture, or video of them saying the message or they will have no picture. A person will be able to have many different messages at one time, and they will be able to have like caller groups, where they can associate different addresses or commonly used addresses with different celebrities. For example you may have your friends email be associated with your favorite athlete and your parents email be associated with a minister like T. D. Jakes. People will be able to create their own message, with or without, picture or video. You can say whatever you want, ex, Yo, You got a package. All messages will be personalized to the celebrities or individual's preference. Messages will come as a pop up when you receive messages.

What I claim as my invention is:

1. A method of using any person, celebrity, athlete, minister, politician, entertainer artists, etc, saying their own version of “You got mail” ex. Special Delivery, when you log into your email account or when you receive an email message or when you receive an instant message from any ISP.

2. The method of claim 1 when using email on your cell phone.

3. The method of claim 1 when using email on a desktop or laptop computer.

4. The method of claim 1 when using email on your PDA.

5. The method of claim 1 where the email message and/or instant messages of the person speaking picture does or does not pop up when you hear the person.

6. The method of claim 1 where the email message and/or instant messages of the person speaking video does or dose not pop up when you hear the person.

7. The method of claim 1 with or without the use of pictures.

8. The method of claim 1 with or without the use of video.

9. The method of claim 1 where you are able to associate different email messages and/or instant messages with different addresses in your email account.

10. The method of claim 1 where you are able to assign different email messages and/or instant messages to different addresses in your account and hear a different message based on who just emailed and/or instant messaged you.

11. The method of claim 1 where you can assign a primary email message/instant message to your account if you have not assigned that person who has emailed you or instant messaged you, and/or also have different people assigned to different messages.

12. The method of claim 1 where you can create you own message to come up when you receive or log into your email account or when you receive an instant message.

13. The method of claim 1 where you can create your own message when you receive or log into your email account , or when you receive an instant message, with or without your picture or any picture you want to use.

14. The method of claim 1 where you can create your own message when you receive or log into your email account, or when you receive an instant message, with or without your video or any video clip you want to use.

15. The method of claim 1 where you can create your own message when you receive or log into your email account, or when you receive an instant message, with or without video of the person that has emailed you.

16. The method of claim 1 where you can create your own message when you receive or log into your email account, or when you receive an instant message, with or without the picture of the person who has emailed you.

17. The method of claim 1 where you can create your own message when you receive or log into your email account, or when you receive an instant message, with or without the picture of the person who has emailed you where the picture of the person pops up.

18. The method of claim 1 where you can create your own message when you receive or log into your email account, or when you receive an instant message, with or without the video of the person who has emailed you where the video of the person pops up.

19. A method of using any person, celebrity, athlete, minister, politician, entertainer artists, etc, saying their own version of “You got mail” pops up on the screen ex. Special Delivery, when you log into your email account, when you receive an email message, or when you receive an instant message.

20. The method of claim 1 where the device that is logged into your email account, or using as an instant messenger, is any electronic device that can receive email.
